(19) United States
(12) Patent Application Publication
(10) Pub. No.: US 2016/0242385 A1
(43) Pub. Date: Aug. 25, 2016

(54) TELESCOPIC ADJUSTABLE PORTION CONTROL PET FEEDER

(71) Applicant: Michael Parness, Foxfield, CO (US)

(72) Inventor: Michael Parness, Foxfield, CO (US)

(21) Appl. No.: 15/076,659

(22) Filed: Mar. 22, 2016

Related U.S. Application Data
(63) Continuation-in-part of application No. 14/627,844, filed on Feb. 20, 2015.

(51) Int. Cl. A01K 5/01; F16M 11/32

(52) U.S. Cl. CPC A01K 5/0114; F16M 11/32

(57) ABSTRACT

The invention relates to a novel pet feeder that has a removable portion control insert to slow a pet's consumption of food kibble. Telescopic hinged legs fold inward upon themselves and lock to create multiple heights so that the feeder can accommodate pets of varying sizes. The legs may be hinged and folded completely inward and under the base piece so that the feeder can also be flush to a surface.

### REFERENCE TO OTHER APPLICATIONS

This is a Continuation-in-part of application Ser. No. 14/627,844 filed on Feb. 20, 2015, and herewith abandoned.

### FIELD

The invention relates to a novel pet feeder that is adjustable to three heights and contains a removable portion control dish portion.

### BACKGROUND OF THE INVENTION

The invention most closely corresponds with USPTO Class 119/51.01 wherein Class 119 relates to animal husbandry and sub-class 51.01 includes feeding devices.

In its simplest form, the invention relates to a novel pet feeder wherein hinged legs can be folded out in one configuration and telescopically extended to a third adjustment to adjust the height of the feeder from a surface so that the feeder can adapt to a growing pet or to provide ergonomically comfortable feeding heights for varying size dogs.

The feeder legs are a sturdy width and hinge unto themselves to ultimately be extended out in stages to a desired distance from a surface. The legs can be hinged inward toward the underside of the base portion and snap into accepting clasps which are molded into the base piece to allow the feeder to sit flush to a surface. If the legs are hinged out in the “second position” the feeder will be approximately three and one half inches from a surface. Within the first hollow leg portion, a solid leg portion is then telescopically released by depressing a button located on the leg that allows this motion and upon release will hold the leg at the “third position” and make the feeder ten (10) inches from a surface.

A unique feature of the feeder is a removable insert bowl that is grooved and shaped to slow the pet's consumption rate. Kibble is poured into the bowl portion and will then randomly rest in the grooves or nooks molded into the bowl. A pet cannot then simply gobble down a bowl of food, but rather must pick its way through the maze of grooves to more carefully select kibble. Further, the bowl portion is removable for easy cleaning.

### THE INVENTION

### SUMMARY, OBJECTS AND ADVANTAGES

It is fairly well known that overweight dogs can experience a myriad of medical problems, which could be avoided by maintaining a healthy weight. These health problems can drastically shorten a dog's life. Weight related illnesses include diabetes, heart disease, arthritis and the list goes on.

It is also known that most dogs do not observe a limit at mealtimes and especially puppies will eat far past the full stage. Thus pet owners have to monitor or measure food, or purchase some feeding device that hopefully controls portions. Not all such feeding devices work well or are practical in all situations.

The inventive feeder is an easy to use method of not only controlling portions, but it is a feeder that can grow with a dog from the puppy stage to the adult stage. The pet owner does not have to purchase different food dishes as the pet grows.

Older dogs often have trouble with their joints and having to extend far over to reach a food bowl sitting on the floor can be painful for them. Conversely, a small dog is not able to reach a feeder that is already extending up from the floor. The inventive feeder easily adjusts for all these eventualities.

There are extendable pet feeders in the art that comprise rod-like legs and a ring wherein a dish may be placed. These feeders are not sturdy or stable. The inventive feeder has telescopic hinged legs that are more than an inch wide and are approximately a half inch thick. This feeder will not wobble or topple as most aforementioned feeders will.

A 3-leg tripod configuration is used for optimum stability at any height. The wide legs snap into the bowl base and then are hinged roughly midway down so that the leg can be folded inward and snap into the base piece. At the base of each leg is a rubber skid resistant pad with raised rubber circle extrusions to add stability to the bowl and aid in preventing the bowl from sliding.

With the legs in the first position the feeder is approximately six (6) and one half inches from a surface. Depressing the button on the outside of a leg releases a second leg portion from within that telescopes out to then create a ten (10) inch high feeder.

A further novel feature is the portion control removable bowl insert. The molded grooves allow for kibble to be spread around the feeder and require the dog to slow down its consumption. The bowl insert is removable for easy cleaning.

### BRIEF DESCRIPTION OF THE DRAWINGS

The invention is described in further detail by reference to thirteen (13) drawings sufficient in detail to describe the invention in which:

FIG. 1 shows the feeder base with the legs hinged out and locked to “second position”;

FIG. 2 underside of the feeder with the legs folded and hinged in upon themselves as would allow the feeder to rest flush to a surface;

FIG. 3 illustrates another angle of the underside of the feeder;

FIG. 4 illustrates the legs extended and locked into “second position” away from the receiving section;

FIG. 5 illustrates another perspective of the feeder with the legs snapped in and out of the receiving section;

FIG. 6 is a magnified view of the legs and the release button which will allow the solid section of the legs to extend when pressed;

FIG. 7 is a magnified view of the hollow section of the leg and the solid section having been telescoped outward after a user depressed the release button;

FIG. 8 shows the inside view of the hollow leg portions and the solid leg portion as extended into “third position”;

FIG. 9 is a magnified version of FIG. 8 so as to better illustrate the features of that Figure;

FIG. 10 is a magnified view of the raised circular rubber anti-skid pads;

FIGS. 11 and 12 11 and 12 show two perspectives of the feeder with legs completely extended causing the feeder to be in “third position”; and

FIG. 13 shows the removable slow feeder insert.

### DETAILED DESCRIPTION, INCLUDING BEST MODES OF CARRYING OUT THE INVENTION

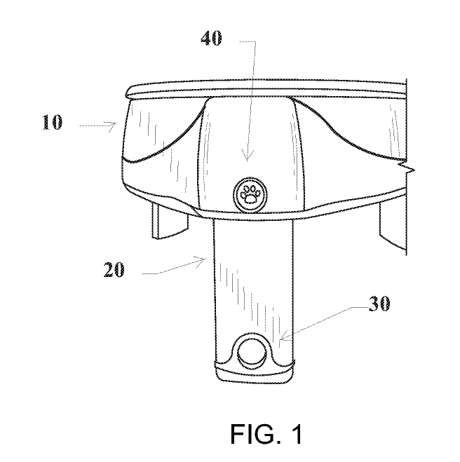

FIG. 1 shows the feeder base 10, with the legs 20 hinged out and locked to “second position”. This configuration is suitable for a medium to large dog. The solid portion of the legs are locked into the hollow portion 30. The push button 40 for releasing the legs into “third position” is shown.

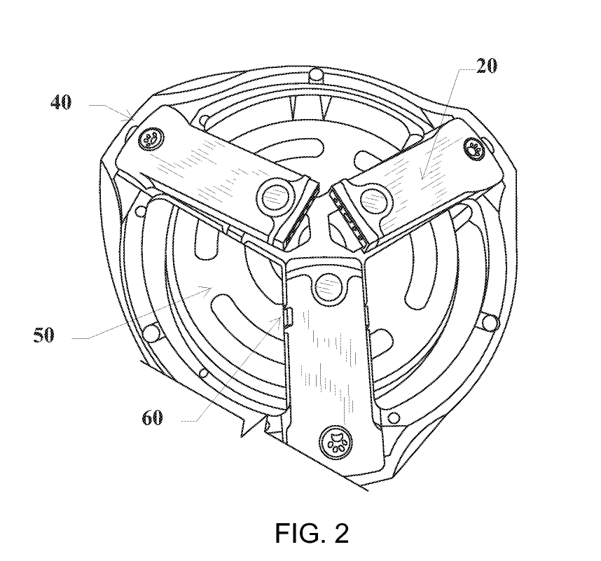

FIG. 2 shows the underside of the feeder 50 with the legs 20 folded and hinged in upon themselves as would allow the feeder to rest flush to a surface. This is ideal for small dogs. The button 40 for releasing the legs is again shown. The legs snap into the receiving section 60 of the base.

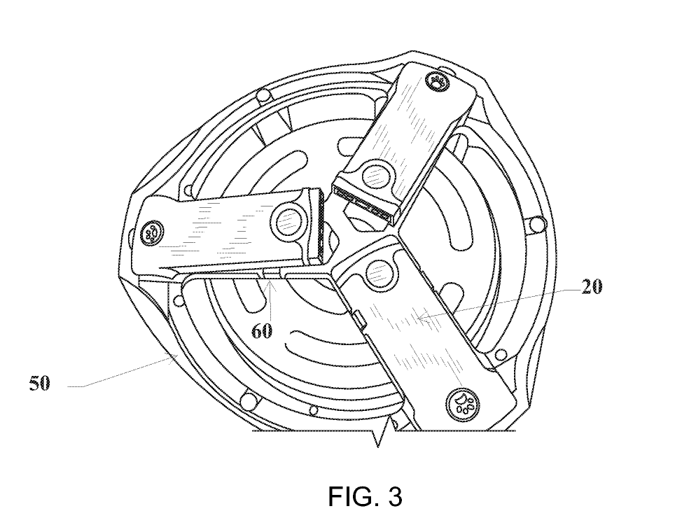

FIG. 3 illustrates another angle of the underside of the feeder 50 with the legs 20 folded inward and snapped into the receiving section 60.

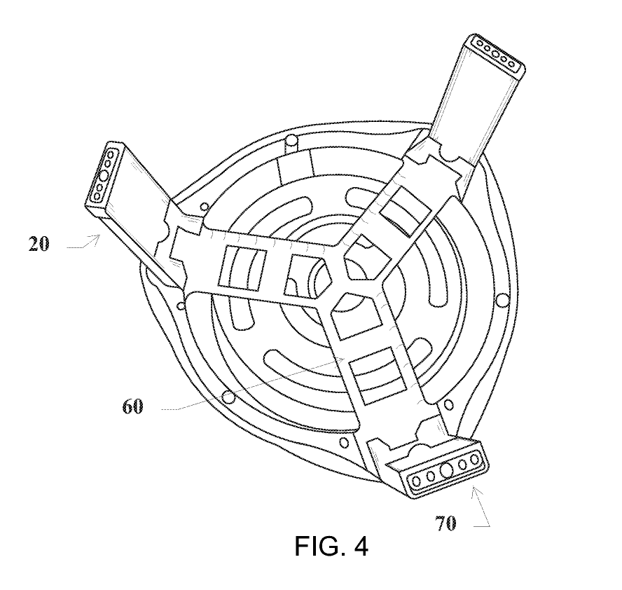

FIG. 4 illustrates the legs 20 extended and locked into “second position” away from the receiving section 60. The raised circle anti-skid pads 70 are shown on the bottom of the legs as would control slipping when the feeder is in this position.

FIG. 5 illustrates another perspective of the feeder with the legs 20 snapped in and out of the receiving section 60. This Figure serves to illustrate the inside of the leg portions as well as another angle of the receiving section 60.

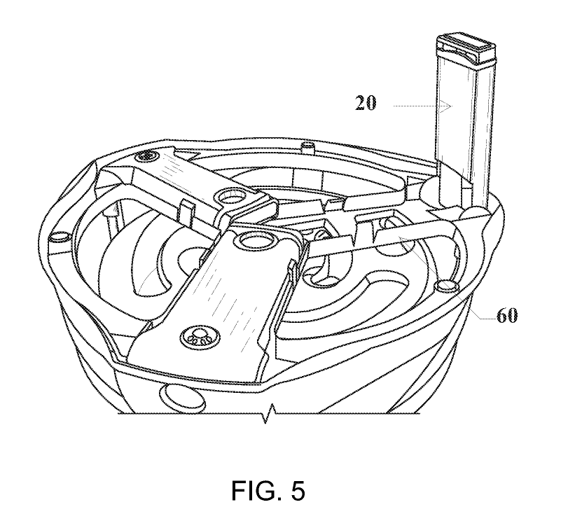

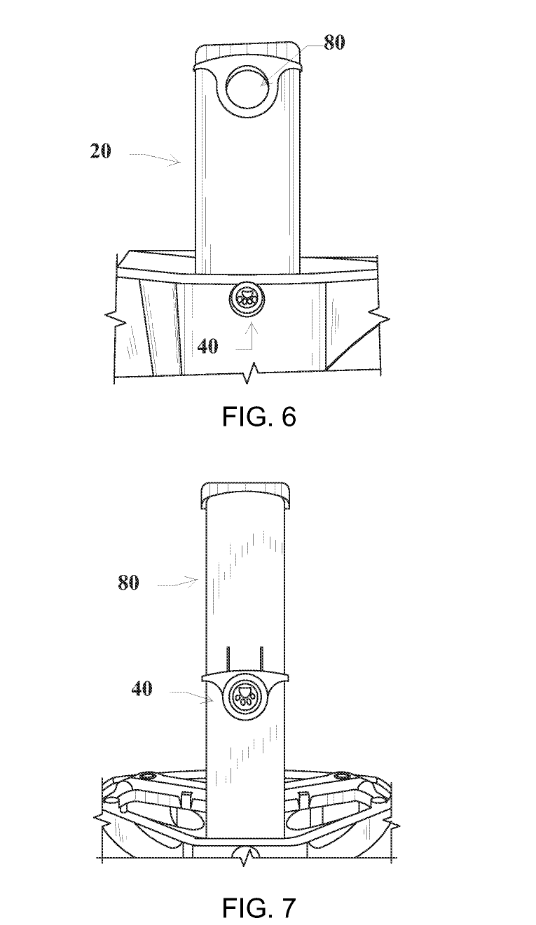

FIG. 6 is a magnified view of the legs 20 and the release button 40 which will allow the solid portion of the legs to extend when pressed. The solid portion of the legs resides inside the hollow portion 80, and cannot be seen in this view.

FIG. 7 is a magnified view of the hollow portion of the leg 20 and the solid portion 80 having been telescoped outward after a user depressed the release button 40. The user simply pulls on the solid portion 80 to extend, and the leg will snap into place allowing the release button 40 to return to an un-pressed state which then locks the leg in place.

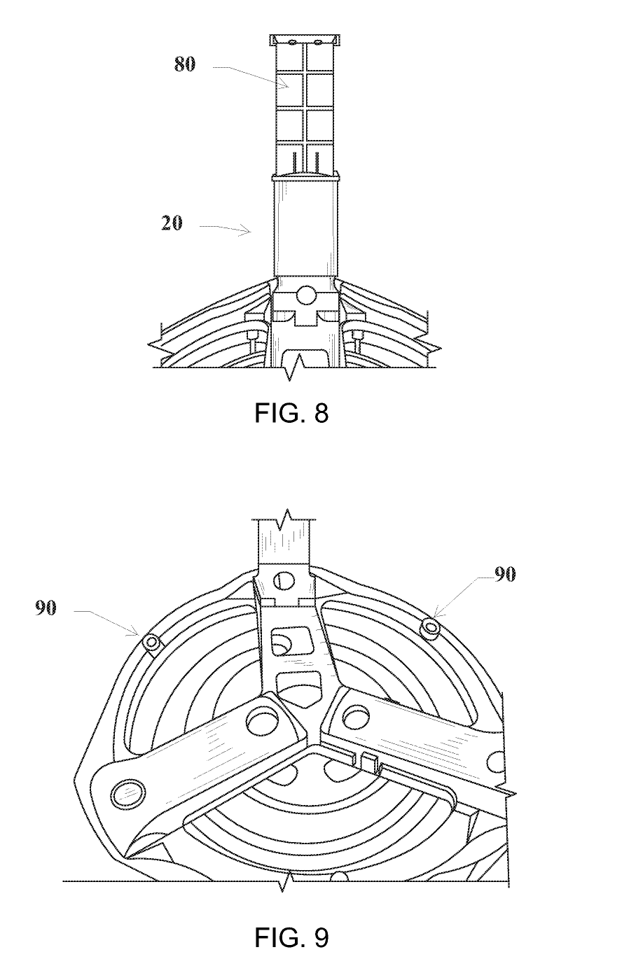

FIG. 8 shows the inside view of the hollow leg portions 20 and the solid leg portion 80 as extended into “third position”.

FIG. 9 is a magnified version of FIG. 8 so as to better illustrate the features of that Figure. This Figure also illustrates the circular rubber anti-skid pads 90 which will contact a surface when the bowl is in “first position” or has the legs folded completely underneath the and snapped into the underside of the feeder. These pads control slipping when the feeder is flush to a surface without legs extended.

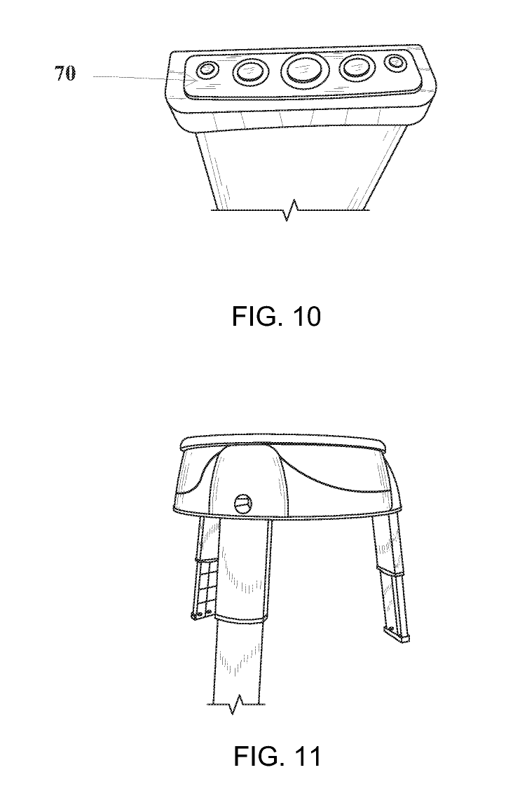

FIG. 10 is a magnified view of the raised circular rubber anti-skid pads 70 which are located at the bottom of each extending leg.

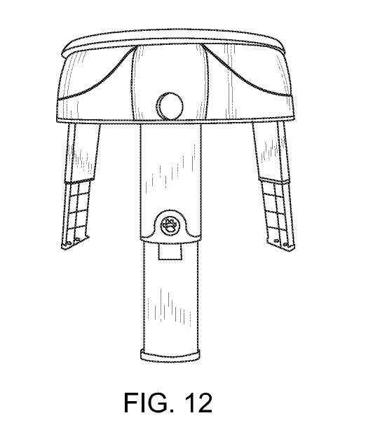

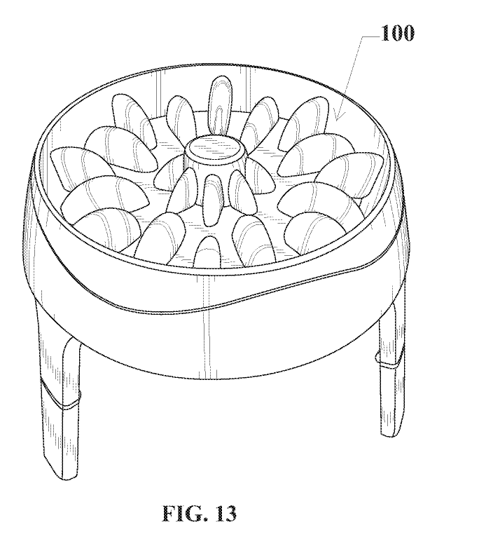

FIGS. 11 and 12 show two perspectives of the feeder with legs completely extended causing the feeder to be in “third position”. This position is ideal for large dogs.

FIG. 13 shows the removable slow feeder insert 100. This insert serves to control the dog's rate of food consumption and is removable for easy cleaning.

1) An adjustable telescopic portion control pet feeder comprising:
a) a base piece for receiving a removable insert
b) a removable grooved bowl insert
c) three hollow hinged and telescopic leg sections
d) three solid telescopic leg sections
e) a receiving section for the legs in the base piece
f) a release button for leg extension
g) anti-skid pads on both base and end of legs.

2) The adjustable telescopic portion control pet feeder as in claim 1 wherein the base piece is specifically molded to accept the grooved bowl insert.

3) The adjustable telescopic portion control pet feeder as in claim 1 wherein the grooved bowl insert is removable and designed to maintain food kibble spread among said grooves so that the pet can only consume the food kibble slowly and selectively.

4) The adjustable telescopic portion control pet feeder as in claim 1 wherein three (3) legs at least a half inch wide are hollow so as to contain the solid leg portions, and wherein the hollow leg sections hinge so as to fold under the feeder or to be extended to create a second height setting for the feeder.

5) The adjustable telescopic portion control pet feeder as in claim 1 wherein three (3) solid leg sections reside within the hollow leg sections and wherein the solid leg sections can be telescopically extended out of the hollow leg sections to create a third height setting for the feeder.

6) the adjustable telescopic portion control pet feeder as in claim 1 wherein a button located on the base is pressed to release each of the solid leg sections from the hollow leg sections and allows the extended leg to lock into place wherein the extension causes the button to return to an un-pressed state.

7) The adjustable telescopic portion control pet feeder as in claim 1 wherein the underside of the base piece contains a receiving section wherein the legs will snap into when folded inward to create a feeder that is placed flush on a surface.

8) The adjustable telescopic portion control pet feeder as in claim 1 wherein each of the legs of the feeder contain rubber anti-skid pads with circular rubber extrusions for added stability when the feeder legs are extended, and which rubber material does not extend outward from or upward around the leg.

9) The adjustable telescopic portion control pet feeder as in claim 1 wherein the base of the feeder contains three (3) circular rubber anti-skid feet for stability when the feeder is flush to a surface and does not have the legs extended.
